(19) United States
(12) Patent Application Publication
(10) Pub. No.: US 2016/0243563 A1
(43) Pub. Date: Aug. 25, 2016

(54) LAWN SPRINKLER FLOW CONTROL DEVICE

(71) Applicants: Peter A. Maksymec, Las Vegas, NV (US); Joseph Ostrowski, Henderson, NV (US)

(72) Inventors: Peter A. Maksymec, Las Vegas, NV (US); Joseph Ostrowski, Henderson, NV (US)

(21) Appl. No.: 15/147,782

(22) Filed: May 5, 2016

Related U.S. Application Data
(62) Division of application No. 13/571,227, filed on Aug. 9, 2012, now abandoned.

(51) Int. Cl. B05B 1/30; B05B 12/08; B05B 15/10

(52) U.S. Cl. CPC B05B 1/3026; B05B 15/10; B05B 12/087

(57) ABSTRACT

A flow control device sized to fit into a pop-up sprinkler inlet reducing the cross-sectional area of the inlet thereby controlling the volume of water by restricting the flow able to pass through and inducing a pressure drop to the sprinkler head for correct droplet formation. A tapered body with spaced ridges permits the flow control device to “snap into” pop-up sprinkler inlets of different sizes. A top surface of the flow control device includes a small opening which acts as the new inlet. A cover cap and stem spring assembly of the pop-up sprinkler are removed from an installed pop-up sprinkler body revealing the inlet allowing the flow control device to be pressed downward into the inlet until one of the ridges snaps in place. The cover cap and stem spring assembly are then returned to the body completing the retrofit. A universal flow control device is also disclosed.

### CROSS-REFERENCE

This application is a divisional application of U.S. application Ser. No. 13/571,227 filed Aug. 9, 2012 and which is incorporated herein for any and all purposes.

### FIELD OF THE INVENTION

This invention relates to a flow control device for controlling water pressure and limiting water flow to sprinkler heads in lawn sprinkler systems, and for preventing water waste from broken sprinkler heads.

### BACKGROUND

In typical lawn sprinkler systems, manifolds of water supply pipes extend beneath the surface to be watered. Sprinkler heads are spaced at intervals around a matrix of buried supply pipes, and are attached to the underground pipes through risers or stems which threadedly engage subterranean fittings and extend vertically to, or above, the surface of the ground. A plurality of heads is usually served through a single valve.

Sprinkler heads may be of the fixed or pop-up variety. Pop-up sprinkler heads allow the sprinkler head to mount relatively close to the surface of the ground, elevating only when activated by water pressure resulting from actuating a valve to the system, either manually or electrically. When the water pressure is shut off, a pop-up sprinkler head will return to its resting position.

A problem with lawn sprinkler systems is their inefficient use and waste of water due to excess water pressure at the sprinkler head. This excess water pressure at the sprinkler head creates a misting or atomization effect at the sprinkler head and much of this mist is lost due to evaporation or wind effects resulting in wasted water. This is especially problematic for geographic areas (e.g., Nevada) experiencing water shortages. Known prior art devices for reducing pressure or controlling water flow involve somewhat complex assemblies which are relatively expensive and may be difficult to retrofit on existing lawn sprinkler systems.

Another very common problem with lawn sprinkler systems is damage to the sprinkler heads caused accidentally or by vandalism, or loss of heads to theft. Sprinkler heads are easily knocked off by pedestrian traffic, children playing on the lawn, lawn maintenance personnel and equipment, and the like. Typically, a single sprinkler valve will service a manifold having multiple sprinkler heads, frequently up to six, eight or more per line. When one sprinkler head is knocked off, water gushes from the broken line, often creating a geyser a number of feet in the air. Depending on the water pressure and the size of the line, water loss through a broken sprinkler head can be anywhere from 10-45 gallons per minute. Thus, even in a short sprinkler cycle, hundreds of gallons of water will be wasted through a broken sprinkler pipe. In addition, flow is diminished through the other sprinkler heads on the line to the point where, if the broken head is not promptly repaired, landscaping will die around the other sprinkler heads on the line. In residential settings, since lawn sprinklers may be activated by a clock for only a few minutes at a time, a broken head may not be noticed for many days, resulting in flooding and erosion in the small area where the system is broken, dying of grass in the area of adjacent sprinkler heads, and a very substantial waste of water.

It would be advantageous to develop a flow restriction device capable of being retrofitted into an existing landscape sprinkler system to provide favorable pressure and flow to each sprinkler head.

### SUMMARY

Accordingly, the flow control device is sized to fit into a pop-up sprinkler inlet to reduce the cross-sectional area of the inlet thereby controlling the volume of water by restricting the flow able to pass through and inducing a pressure drop to the sprinkler head for correct droplet formation by the nozzle. In one embodiment, the flow control device is funnel-shaped or tapered with spaced ridges permitting the flow control device to “snap into” pop-up sprinkler inlets of different sizes. A top or bottom surface of the flow control device includes an opening smaller than the pop-up sprinkler inlet whereby the flow control device opening acts as the new inlet.

One of the benefits of the flow control device disclosed herein is the ease with which the flow control device may be retrofitted into an installed pop-up sprinkler. In general, the cover cap and stem spring assembly of the pop-up sprinkler are removed from an installed pop-up sprinkler body such that the inlet at the bottom of the body is revealed. Then, the flow control device is pressed downward through the body into the inlet until one of the ridges snaps into the inlet whereby the ridge maintains the flow control device in place against water pressure traveling through the inlet and body. Finally, the cover cap and stem spring assembly are returned to the body completing the retrofit. Given the depth of the body, an elongated tool may be used to press the flow control device into the inlet which is integrated into the bottom the body.

Other variations, embodiments and features of the present invention will become evident from the following detailed description, drawings and claims.

### BRIEF DESCRIPTION OF THE DRAWINGS

FIG. 1 illustrates a conventional pop-up sprinkler of the type which the embodiments of the present invention may be used;

FIG. 2 illustrates a cross-sectional view of a conventional pop-up sprinkler of the type which the embodiments of the present invention may be used;

FIG. 3 illustrates a perspective view of the flow control device according to the embodiments of the present invention;

FIG. 4 illustrates a side view of the flow control device according to the embodiments of the present invention;

FIG. 5 illustrates a top view of the flow control device according to the embodiments of the present invention;

FIG. 6 illustrates a bottom view of the flow control device according to the embodiments of the present invention;

FIG. 7 illustrates a cross-sectional view of the flow control device installed in a first pop-up sprinkler according to the embodiments of the present invention;

FIG. 8 illustrates a cross-sectional view of the flow control device installed in a second pop-up sprinkler according to the embodiments of the present invention;

FIG. 9 illustrates an exemplary tool which may be used to install the flow control device according to the embodiments of the present invention;

FIG. 10 illustrates a flow chart detailing a method of installing the flow control device according to the embodiments of the present invention;

FIGS. 11a and 11b illustrate an exploded perspective view and perspective view of an alternative embodiment having multiple openings according to the embodiments of the present invention; and

FIG. 12 illustrates a side view of a universal flow control device according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

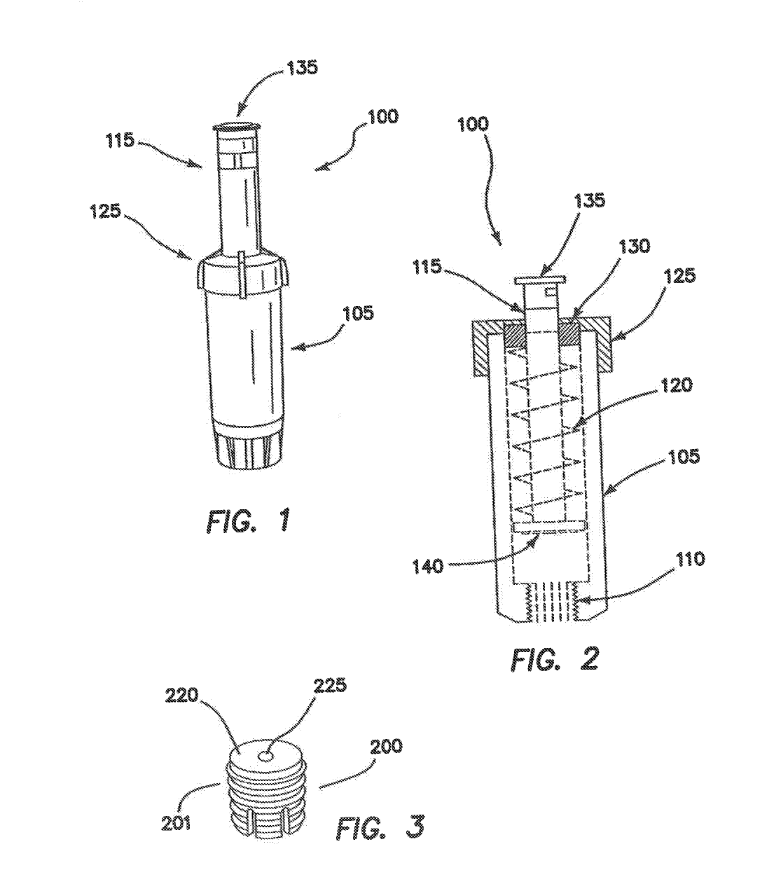

FIGS. 1 and 2 show a conventional pop-up sprinkler 100 of the type with which the flow control device 200 described herein may be used. The pop-up sprinkler 100 comprises a body 105, inlet 110, stem 115, spring 120, cap 125, wiper seal 130, nozzle 135 and optional check valve 140. FIG. 1 shows the pop-up sprinkler 100 with the stem 115 in an external position relative to the body 105 such that water may be dispensed. Water traveling through the inlet 110 causes the stem 115, via water pressure, to move to the external position. When the water stops, the spring 120 causes the stem 115 to return to an internal position within the body 105.

FIGS. 3 through 6 show various views of the flow control device 200 according to the embodiments of the present invention. The flow control device 200 is formed of a generally hollow circular body 201 defining a passageway and including a top end 205, bottom end 210 and ridges 215 (four as shown) forming, or circumscribing, an outer surface of the body 201. While four ridges 215-1 through 215-4 are shown, depending on the embodiment, the number of ridges may be more or less. As shown, the body 201 of the flow control device 200 tapers from narrow at the bottom end 210 to wide at the top end 205. In other words, outermost edges 216 of each successive ridge 215 extends further outward from the bottom end 210 to the top end 205 creating the taper. With this tapered, ridged design, the flow control device 200 is able to fit into inlets of varying sizes. The flow control device 200 may also be dimensioned to fit into an elbow of an irrigation system such that it controls the flow in the same manner as described herein when inserted into the inlet 110.

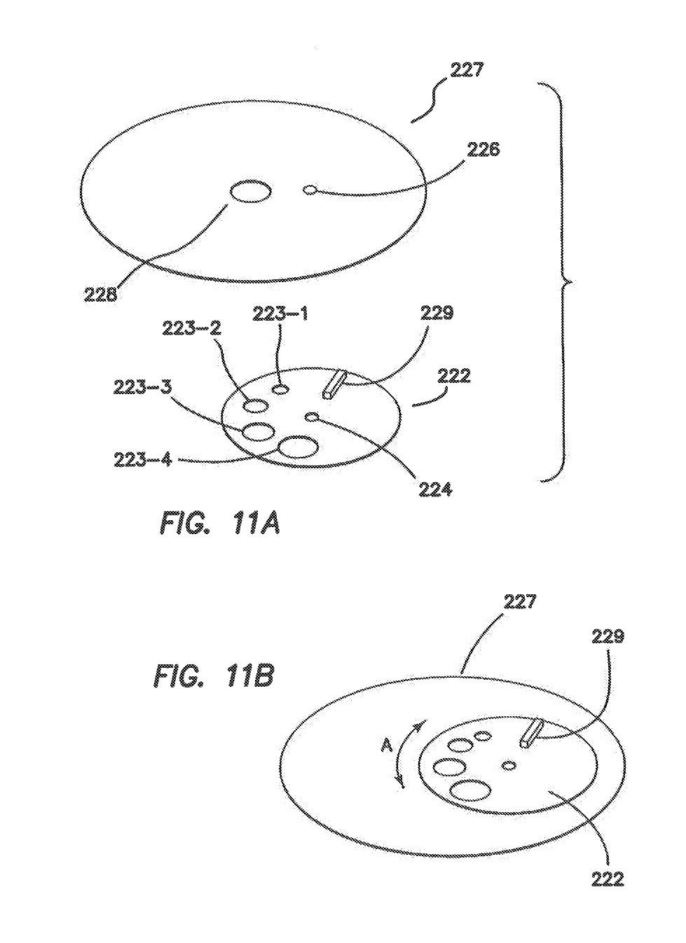

A cap 220 on a top end 205 of the flow control device 200 includes an opening 225 smaller than the passageway opening at the bottom end 210 such that the opening 225 essentially becomes the new inlet for the pop-up sprinkler 100. As shown in FIG. 11a and 11b, more than one opening may be incorporated as well. The flow control device 200 may be a single piece or the cap 220 may be a separate piece connected to the body 201. The degree of flow restriction imparted by the flow control device 200 generally depends upon the size of the opening but may also depend on characteristics of the sprinkler head used, and the water pressure. The connection of the cap 220, if separate, may be accomplished using adhesives, friction or other suitable means. The connection of the cap 220, may also extend in a conical shape upwards and be cut different locations to create the ideal size opening. The connection of the cap 220 may also have a movable part in order to select different opening sizes to optimize the flow (see FIGS. 11a and 11b).

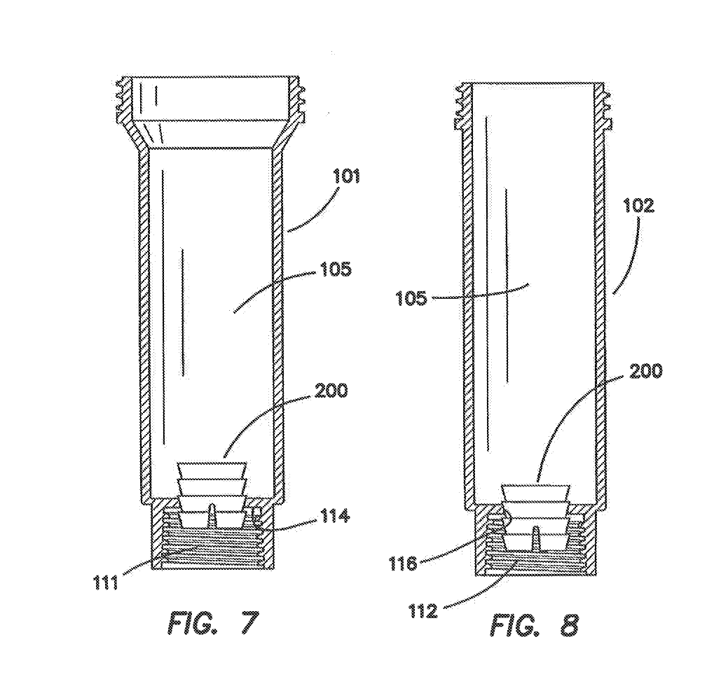

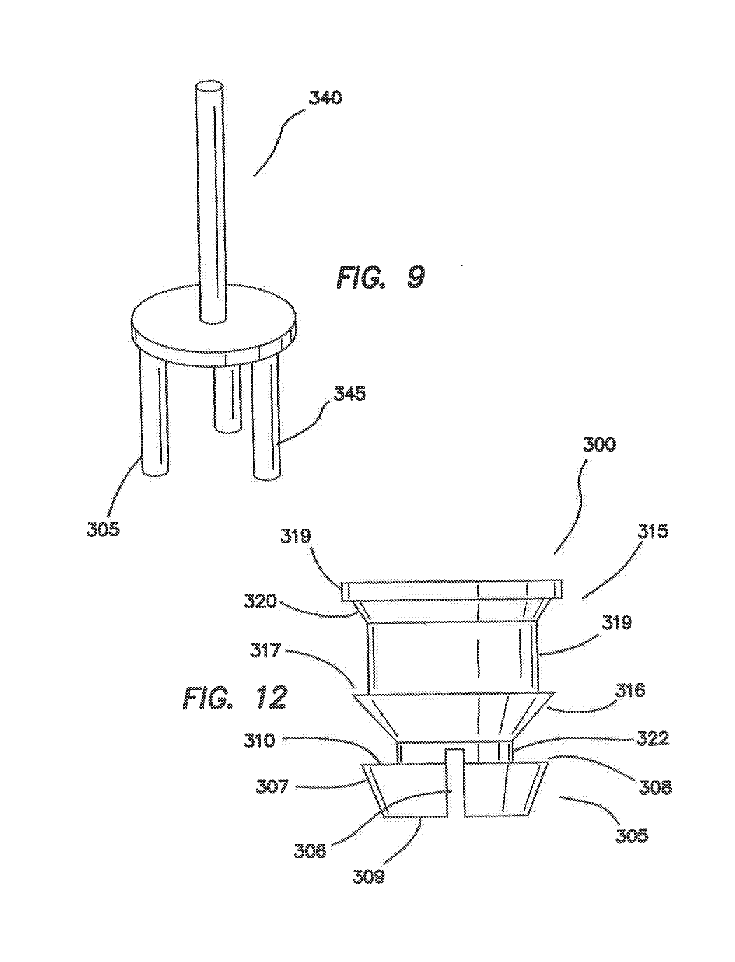

FIGS. 7 and 8 show cross-sectional views of a flow control device 200 installed in a first pop-up sprinkler 101 (Toro 570 and a flow control device 200 installed in a second pop-up sprinkler 102 (Rainbird 1800) according to the embodiments of the present invention. In FIG. 7, the flow control device 200 fits snugly into inlet 111 of the pop-up sprinkler 101 with three 215-1 through 215-3 of the four ridges 215-1 through 215-4 inserted into the inlet 111. In FIG. 8, the flow control device 200 fits snugly into inlet 112 of the pop-up sprinkler 102 with two 215-1 through 215-2 of the four ridges 215-1 through 215-4 inserted into the inlet 113. Thus, a top surface 217 of one of the ridges 215 catches an underside 114 and 116 of the inlets 111 and 112, respectively, thereby maintaining the flow control device 200 in place.

FIG. 9 shows an exemplary insertion tool 300 of the type suitable to install the flow control device 200 into the pop-up sprinkler 100, 101 and 102. The tool 300 includes a number of prongs 305 which retain the top end of the flow control device 200 allowing a user to guide the second end of the flow control device through the body of the pop-up sprinkler to the inlet where the second end is inserted until the flow control device 200 snaps into place responsive to one of the ridges catching an underside of the inlet. Other tools may be used to accomplish the same objective. In another embodiment, a flow control device may be inserted into the inlet 112 from below after the pop-up sprinkler 100, 101 and 102 is removed from the ground and water irrigation system. That is, the inlet 112 cross-section may be reduced from below as well as from above.

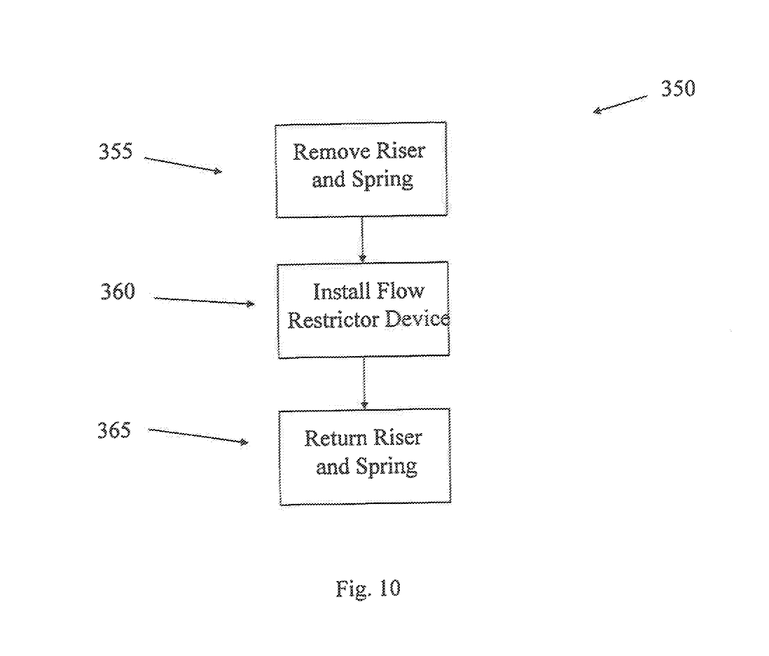

FIG. 10 shows a flow chart 350 detailing one method of installing the flow control device 200. At 355, a stem and spring are removed from a subject pop-up sprinkler. At 360, a flow control device 200 is installed by snapping into the inlet using a tool or finger if possible. At 360, the stem and spring are returned to the pop-up sprinkler body thereby completing the retrofit.

FIGS. 11a and 11b show an alternative flow control device configured to allow a user to select an opening size. As shown, four opening sizes are possible. A rotatable plate 222 includes four openings 223-1 through 223-4. A center opening 224 rotatably joins opening 226 permitting the plate 222 to rotate (as identified by arrow A) in an offset relationship relative to a fixed cap 227 with a single opening 228 matching the size of the largest opening 223-4 in the rotatable plate 222. The center opening 224 may be designed to receive a tool for rotation. With this design, the rotatable plate 222 is rotated via a raised lip 229 or the center opening 224 until a desired opening 223-1 through 223-4 aligns with the opening 228.

FIG. 12 shows a universal flow control device 300 including a first portion 305 configured to fit into many conventional sprinkler pop-ups and a second portion 315 configured to fit into a Rainbird® 1800. The first portion 305 includes 4 vertical cutouts 306 (only one visible in FIG. 12) and a tapered outer wall 307 forming a lower ridge 308. In one embodiment, the lower ridge 308 is 3.25 mm in height and has a lower edge 309 diameter of 12 mm and tapers to a 13.46 mm diameter at a top edge 310. Above the first portion 305 is a tapered wall 316 forming an intermediary ridge 317. In one embodiment, the distance between the top edge 310 and tapered wall 316 is 2.5 mm provided by a vertical wall 322. Above a top edge 318 of the tapered wall 316, a vertical wall 319 extends to an upper tapered wall 320 extending to a lip 319. In one embodiment, the vertical wall 319 is 4.5 mm in height, the tapered wall 320 is 1.7 mm in height and the lip 319 is 1.8 mm in height while the vertical wall 319 defines a 14.25 mm diameter with the tapered wall 320 defining a diameter of 15.85 mm at a top edge thereof and an outer edge of the lip 319 defining a 16.25 mm diameter. In practice the first portion 305 fits into and is retained by the inlet of most conventional pop-up sprinklers but with the Rainbird® 1800 the first portion 305 extends through the inlet so that the wider second portion 315 inserts and is retained by the inlet thereof. In other words, the lower ridge has a smaller maximum diameter than said intermediary ridge. The dimensions are exemplary only and are determined, in this instance, to accommodate many conventional pop-up sprinklers and the Rainbird® 1800.

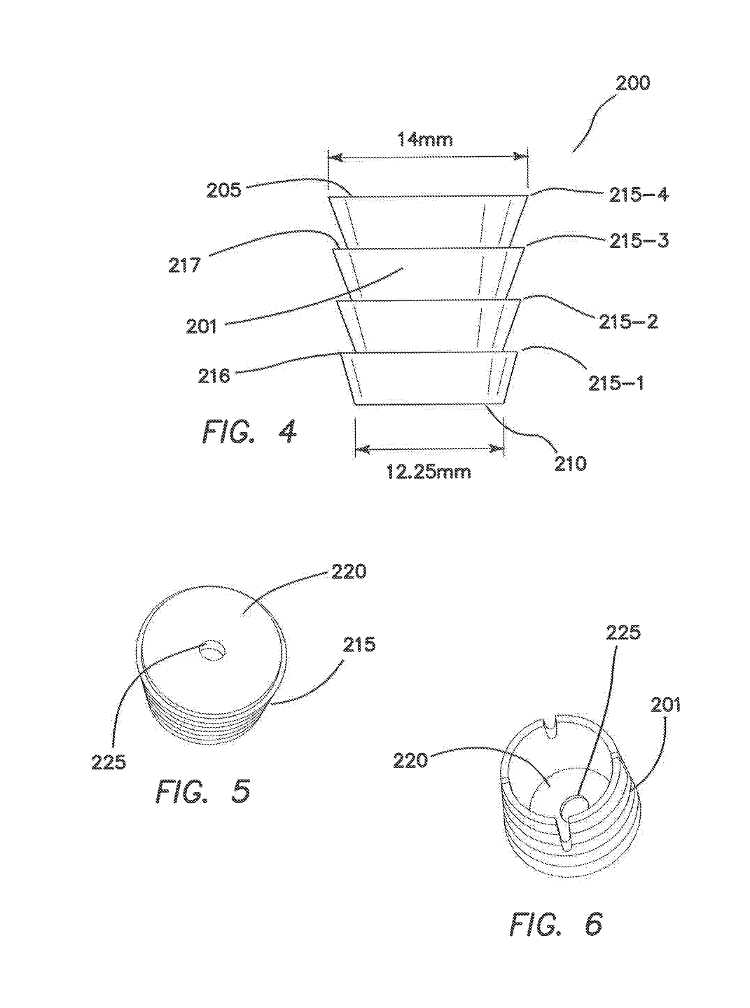

The flow control device 200 described herein may be made of plastics, alloys, metals, composites, polymers, resins and the like and may be made using molding, rapid prototyping and machining techniques. In one embodiment, as shown in FIG. 4, the bottom end 210 of the flow control device 200 is 12.25 mm in diameter while the top end 205 has a diameter of 14 mm. These dimensions are exemplary and may be altered without departing from the spirit and scope of the embodiments of the current invention.

Although the invention has been described in detail with reference to several embodiments, additional variations and modifications exist within the scope and spirit of the invention as described and defined in the following claims.

We claim:

1. A flow control device comprising:
a cylindrical body defining a passageway and having a top end and bottom end, said cylindrical body wherein said top end has a greater diameter than said bottom end;
one or more ridges extending outward from said cylindrical body between said top end and said bottom end, said ridges having outer walls angled upward and horizontal upper surfaces; and
an opening in said top end, said opening in communication with said passageway.

2. The flow control device of claim 1 wherein said bottom end is dimensioned to fit into an inlet of a pop-up sprinkler.

3. The flow control device of claim 1 wherein said body is cylindrical.

4. The flow control device of claim 1 further comprising one or more vertical cut-outs in said body.

5. An apparatus comprising:
a body containing at least a stem, spring assembly and inlet;
a flow control device comprising a:
a body defining a passageway, said body tapered from a top end to a bottom end such that said top end has a greater diameter than said bottom end;
one or more ridges extending outward from said body between said top end and said bottom end; and
an opening in said top end, said opening in communication with said passageway; and
wherein a bottom end of said flow control device is inserted into said inlet.

6. The apparatus of claim 5 wherein said body is cylindrical.

7. The apparatus of claim 5 wherein said one or more ridges extend outward from said body between said top end and said bottom end, said ridges having outer walls angled upward and horizontal upper surfaces.

8. The flow control device of claim 5 further comprising one or more vertical cut-outs in said body.

9. An apparatus comprising:
a sprinkler body containing at least a stem, spring assembly and inlet;
a flow control device comprising:
a flow control body defining a passageway, said flow control body having a top end and a bottom end wherein outermost edges of each successive ridge extend further outward from said bottom end to said top end such that said top end has a greater diameter than said bottom end permitting said flow control body to insert into inlets of varying sizes, said multiple ridges configured to insert into an inlet until a top surface of one of said multiple ridges catches an underside of said inlet thereby maintaining the flow control device in place;
an opening in said top end, said opening in communication with said passageway; and
wherein said bottom end of said flow control device is inserted into said inlet until a top surface of one of said multiple ridges catches an underside of said inlet thereby maintaining the flow control device in place.
